(19) United States
(12) Patent Application Publication
(10) Pub. No.: US 2006/0202960 A1
(43) Pub. Date: Sep. 14, 2006

(54) Mouse with adjustable center of gravity

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,666

(22) Filed: Mar. 8, 2005

(51) Int. Cl. G09G 5/08

(52) U.S. Cl. 345/163

(57) ABSTRACT

A mouse with adjustable center of gravity has a casing and a weight. The casing has an accommodating space formed therein, and the weight is received in the accommodating space. The weight can be used to adjust easily the center of gravity of the mouse. Hence, the center of gravity of the mouse is adjustable according to the operation habit or different demands of a user, and the mouse is convenient and comfortable.

### BACKGROUND OF THE INVENTION

1. Field of the Invention

The present invention relates to a mouse with an adjustable center of gravity, and particularly relates to a mouse having a center of gravity adjustable according to the operation habit or different demands of a user.

2. Description of Related Art

A mouse is an important tool for computer use. It is easy and convenient for a user to control a computer using a mouse. Therefore, the mouse is a necessary input device for different grades of computers. The optical mouse and mechanical mouse have been popular for a long time.

The mechanical mouse has a ball installed in a bottom portion thereof. The ball has a plastic coating formed thereon. When the mouse is slid on a desk, the ball rolls and makes an X-direction roller and a Y-direction rotate. The rotation of the X-direction roller and the Y-direction roller is used to drive two decoding rollers, respectively. A light-emitting element is disposed on the decoding roller for emitting a visible light or an infrared light. When the light passes through the decoding roller to a receiving element of the mechanical mouse, a controlling circuit of the mechanical mouse will obtain a low potential. When the decoding roller shields the light from the light-emitting element, the receiving element is unable to receive the light. Therefore, the controlling circuit will obtain a high potential. The mechanical mouse thus obtains a serial low or high potential according to the rotation of the decoding roller. A CPU of the mechanical mouse is then used to process the low or high potential for detecting the direction and the location of the mouse.

The optical mouse lacks the roller of the mechanical mouse, but has two sets of photoelectric detectors. The two sets of photoelectric detectors represent the X-direction and Y-direction, respectively. The optical mouse must be used on a special board. The special board has a plurality of nets formed thereon. When a light is emitted from a light-emitting element of the optical mouse to a space portion of the special board and is reflected from the special board to a receiving element of the optical mouse, a controlling circuit of the optical mouse will obtain a low potential. When a light is emitted on a line of the net of the special board and is absorbed by the line of the net, the receiving element is unable to receive the light. Therefore, the controlling circuit will obtain a high potential. A CPU of the optical mouse is used to process the low or high potential for detecting the direction and the location of the mouse.

For both the optical mouse and mechanical mouse, the center of gravity of the mouse is fixed. The center of gravity of the mouse is thus not adjustable according to the operation habit (right or left) or different demands of user, and it is not convenient and comfortable for users to use the conventional mouse.

### SUMMARY OF THE INVENTION

The present invention provides a mouse with adjustable center of gravity. The mouse has a center of gravity adjustable according to the operation habit or different demands of user. Hence it is convenient and comfortable for users to use the mouse.

One aspect of the invention is a mouse with adjustable center of gravity. The mouse comprises a casing and a weight. The casing has an accommodating space formed therein, and the weight is received in the accommodating space. The weight is used to adjust the center of gravity of the mouse.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective, exploded view of the prevent invention;

FIG. 2 is a perspective, assembled view of the prevent invention;

FIG. 3 is a bottom view of the prevent invention;

FIG. 4 is a top view of the prevent invention;

FIG. 5 is a top view according to one embodiment of the prevent invention;

FIG. 6 is a top view according to another embodiment of the prevent invention; and

FIG. 7 is a top view according to further another embodiment of the prevent invention.

### DETAILED DESCRIPTION OF PREFERRED EMBODIMENTS

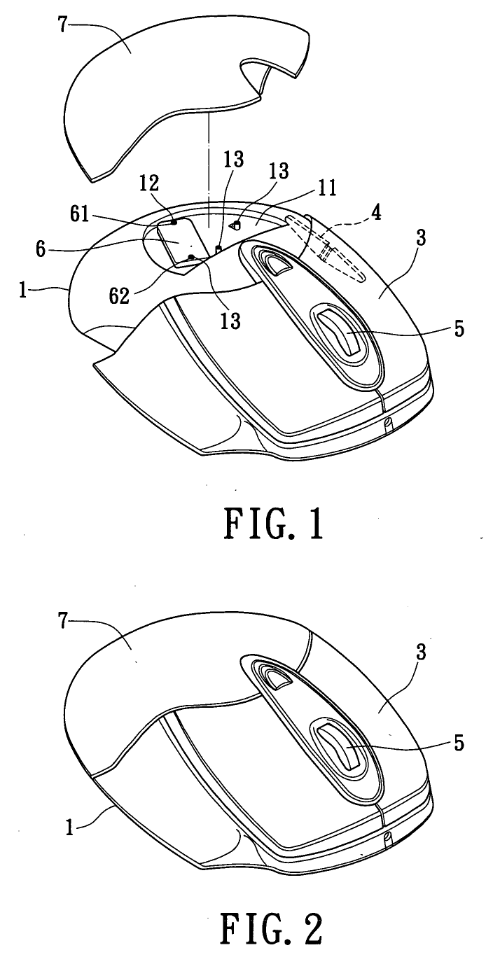

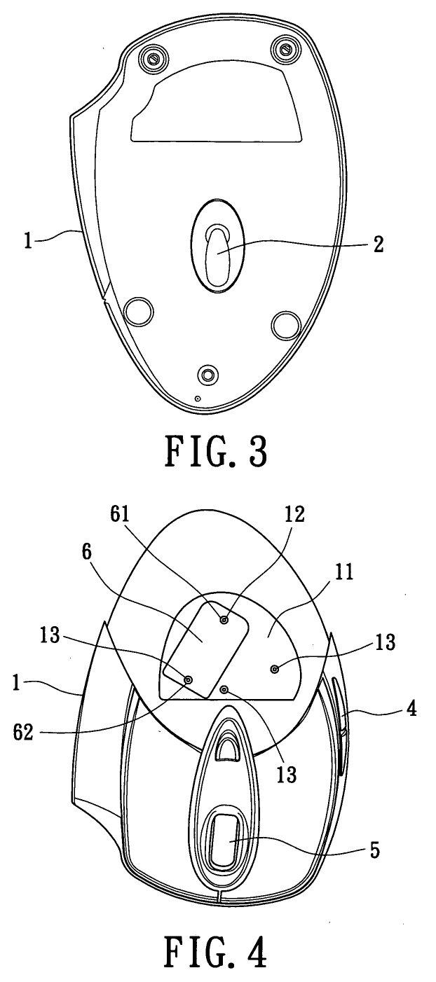

Referring to FIGS. 1 and 4, the present invention provides a mouse for adjusting the center of gravity. The mouse includes a casing 1, a cursor control module 2, a plurality of keys 3, 4 and roller 5. The casing 1 is a hollow casing, and has a PCB (not shown) assembled therein. The cursor control module 2 is mechanical or optical-type. The cursor control module 2 is assembled on the PCB. The cursor control module 2 electrically connects with the PCB, and is exposed from a bottom portion of the casing 1 for controlling the movement direction and distance of the cursor of the mouse. The keys 3, 4 and the roller 5 are disposed on the casing 1, and electrically connect with the PCB. The function of the mouse of the present invention is sane as that of the prior art. In other words, the mouse can be used to execute commands from a function list, or select a word or pattern in on the computer screen, and scroll the display on the screen with roller 5.

The casing 1 has an accommodating space 11 formed in a top side thereof or any suitable location thereof. A weight 6 is received in the accommodating space 11. The weight 6 with a flat shaped is made of heavy material, such as metal material. The weight 6 is smaller than the accommodating space 11. The weight 6 can be received in any location of the accommodating space 11.

The weight 6 has a first fixed hole 61 and a second fixed hole 62. The first fixed hole 61 and the second fixed hole 62 are circuit holes. A first fixed post 12 and a plurality of second fixed posts 13 are disposed in the accommodating space 11. The first fixed hole 61 and the second fixed hole 62 correspond to the first fixed post 12 and the second fixed post 13. The second fixed posts 13 are disposed on a front side, a front-left side and a front-right side of the first fixed post 12. A distance between the first fixed post 12 and each the second fixed post 13 is the same as that between the first fixed hole 61 and the second fixed hole 62.

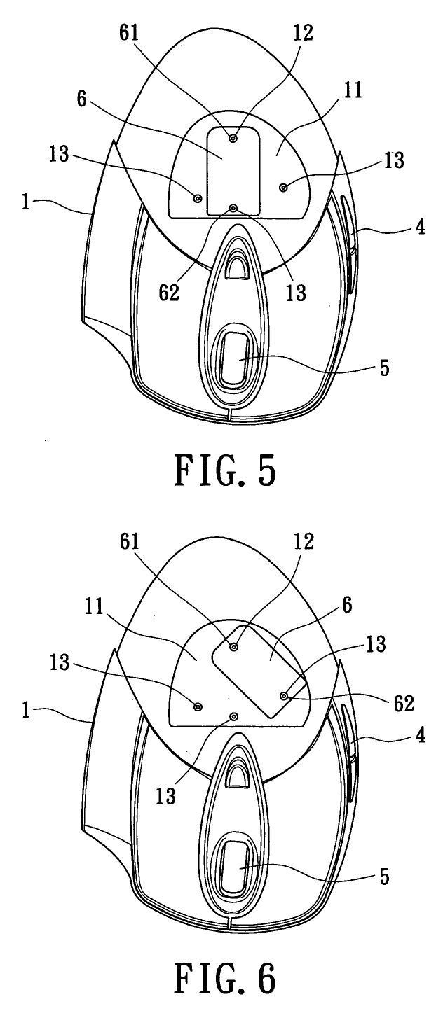

The first fixed hole 61 mates with the first fixed post 12, and the second fixed hole 62 selectively mates with one of the second fixed posts 13. The weight 6 can be rotated relative to the first fixed post 12 to three different locations (as shown in FIGS. 4-6).

A cover 7 is fixed over the accommodating space 11 by a retaining method for covering the weight 6 and the accommodating space 11. The cover 7 can press the weight 6 to retain the weight 6 in the accommodating space 11.

The weight 6 is installed in the mouse to adjust the center of gravity of the mouse. Moreover, the center of gravity of the mouse is easily adjusted by changing the location of the weight 6. The center of gravity of the mouse can thus be adjusted according to personal preference when using the mouse.

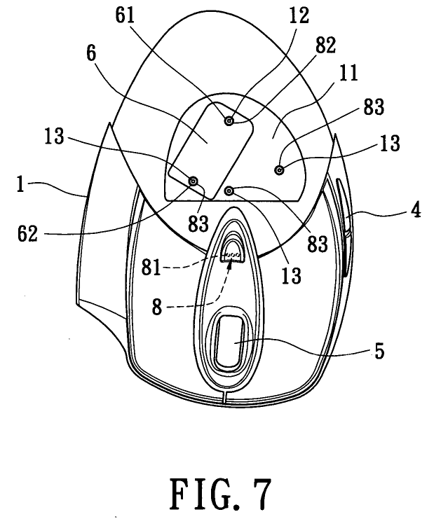

Referring to FIG. 7, a display device 8 is disposed on the casing 1 for showing the location of the weight 6. The display device 8 has a plurality of indicator lights 81 corresponding to the second fixed posts 13. The first fixed post 12 has a first conductive point 82 formed thereon. Each of the second fixed posts 13 has a second conductive point 83 formed thereon. The first conductive point 82 and the second conductive points are made of metal materials with good conductibility. The first conductive point 82 and -the second conductive point 83 can be electrically connected with the first fixed hole 61 and the second fixed hole 62, respectively. The indicator lights 81, the first conductive point and the second conductive points are electrically connected to a PCB (not shown in FIG.).

When the location of the weight 6 is varied, the first conductive point 82 of the first fixed post 12 can be electrically connected to one of the second conductive points 83 of the second fixed posts 13 that mates with the weight 6. Therefore, the indicator light 81 that corresponds to the second conductive point 83 is illuminated. The indicator lights can thus be used to show the location of the weight 6 without opening the cover 7.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mouse with an adjustable center of gravity, comprising:
a casing having an accommodating space formed therein; and
a weight received in the accommodating space;
whereby the weight is used to adjust the center of gravity of the mouse.

2. The mouse as claimed in claim 1, wherein the accommodating space is a concave space formed in the casing.

3. The mouse as claimed in claim 1, wherein the casing has a cover fixed on the accommodating space for covering the weight and the accommodating space.

4. The mouse as claimed in claim 1, further comprising a cursor control module, a roller and a plurality of keys disposed on the casing for electrically connecting to a PCB.

5. The mouse as claimed in claim 1, wherein the weight is movably received in the accommodating space.

6. The mouse as claimed in claim 1, wherein the weight has a first fixed hole and a second fixed hole, and a first fixed post and a plurality of second fixed posts are disposed in the accommodating space, wherein a distance between the first fixed post and each the second fixed post is equal to that between the first fixed hole and the second fixed hole, and wherein the first fixed hole mates with the first fixed post, and the second fixed hole selectively mates with one of the second fixed posts.

7. The mouse as claimed in claim 1, further comprising a display device disposed on the casing for showing allocation of the weight.

8. The mouse as claimed in claim 7, wherein the display device has a plurality of indicator lights corresponding to the second fixed posts, the first fixed post has a first conductive point formed thereon, and each of the second fixed posts has a second conductive point formed thereon, and wherein the first conductive point and the second conductive point are electrically connected with the first fixed hole and the second fixed hole, respectively.
